(19) United States
(12) Patent Application Publication
(10) Pub. No.: US 2019/0370787 A1
(43) Pub. Date: Dec. 5, 2019

(54) SYSTEM AND METHODS FOR SHARING A PRIMARY ACCOUNT NUMBER AMONG CARDHOLDERS

(71) Applicant: Mastercard International Incorporated, Purchase, NY (US)

(72) Inventors: Madeline F. Mueller, St. Paul, MO (US); Christopher T. Scholl, Saint Peter's, MO (US)

(73) Assignee: Mastercard International Incorporated, Purchase, NY (US)

(21) Appl. No.: 15/993,382

(22) Filed: May 30, 2018

(51) Int. Cl. G06Q 20/34; G06Q 20/40; G06Q 20/42

(52) U.S. Cl. CPC G06Q 20/35785; G06Q 20/42; G06Q 20/409

(57) ABSTRACT

A shared access payment account system includes a memory device and a processor. The processor is programmed to receive user identification data corresponding to a primary cardholder and generate a user account from the data. The processor is also programmed to receive a request from the primary cardholder to create a shared account number, link the primary account number to the shared account number, and create one or more limitations on the use of the shared account number by one or more secondary cardholders. The shared account number and the limitations are stored in the memory device as shared account number data. The processor is programmed to transmit the shared account number data to the secondary cardholders, receive a transaction authorization message associated with a transaction by the shared account number, determine whether the transaction violates the limitations, and decline the transaction if one or more of the limitations are violated.

### FIELD OF THE DISCLOSURE

The field of the disclosure relates generally to systems and methods for sharing account numbers and, more particularly, to systems and methods for establishing a shared account number, sharing the shared account number with one or more secondary cardholders, and creating limitations on the use of the shared account number by the secondary cardholders.

### BACKGROUND OF THE DISCLOSURE

The use of payment cards, such as debit and credit cards, is common in the marketplace. However, typically the consumer must present the card to the merchant to be processed through a point-of-sale device. In such instances, the consumer may be required to provide a personal identification number or a signature in order for the transaction to be processed. If the consumer wanted another authorized user to make a purchase on the payment card, the physical card must be transferred to the authorized user. However, when the two consumers are in separate locations, such a transfer is not immediately possible.

Alternatively, consumers may have the payment card stored in a digital wallet on a mobile computing device. A digital wallet provides consumers with a secure and convenient way to pay for purchases from accepting merchants. Upon registration, consumers may store their payment card in the digital wallet and may access that information to pay conveniently and securely across participating merchants. However, currently it is not possible to transfer the digital wallet payment card information to another consumer for use.

### BRIEF DESCRIPTION OF THE DISCLOSURE

This summary is not intended to identify essential features of the present disclosure and is not intended to be used to limit the scope of the claims. These and other aspects of the present disclosure are described below in greater detail.

In one aspect, a shared access payment account system for sharing a primary account number among cardholders is provided. The shared access payment account system includes a memory device for storing data, and a processor communicatively coupled to the memory device. The processor is programmed to receive user identification data corresponding to a primary cardholder. The user identification data includes personal data relating to the identity of the primary cardholder. The processor is also programmed to generate a user account from the user identification data for the primary cardholder. Furthermore, the processor is programmed to receive a request from the primary cardholder to create a shared account number, receive a request from the primary cardholder to link the primary account number to the shared account number, and receive a request from the primary cardholder to establish one or more limitations on the use of the shared account number by a secondary cardholder. In addition, the processor is programmed to store the shared account number and the one or more limitations in the memory device as shared account number data, and to transmit the shared account number data to the secondary cardholder. Moreover, the processor is programmed to receive a transaction authorization message associated with a transaction by the shared account number, determine whether the transaction violates at least one of the one or more limitations, and decline the transaction if one or more of the limitations are violated.

In another aspect, a computer-implemented method for sharing a primary account number among cardholders is provided. The method includes receiving user identification data corresponding to a primary cardholder. The user identification data includes personal data relating to the identity of the primary cardholder. The method also includes generating a user account from the user identification data for the primary cardholder. Furthermore, the method includes receiving a request from the primary cardholder to create a shared account number, receiving a request from the primary cardholder to link the primary account number to the shared account number, and receiving a request from the primary cardholder to establish one or more limitations on the use of the shared account number by a secondary cardholder. The method also includes storing the shared account number and the one or more limitations in the memory device as shared account number data and transmitting the shared account number data to the secondary cardholder. Moreover, the method includes receiving a transaction authorization message associated with a transaction by the shared account number, determining whether the transaction violates at least one of the one or more limitations, and declining the transaction if one or more of the limitations is violated.

### BRIEF DESCRIPTION OF THE DRAWINGS

Embodiments of the present disclosure are described in detail below with reference to the attached drawing figures, wherein:

FIG. 1 is a block diagram of an example multi-party payment card network system having a shared access payment account system;

FIG. 2 is a simplified block diagram of an example transaction processing system (TPS) for providing access to a shared primary account number and/or a virtual primary account number using the shared access payment account system shown in FIG. 1;

FIG. 3 is an example configuration of a user system operated by a user, such as a cardholder of the multi-party payment card network system shown in FIG. 1;

FIG. 4 is an example configuration of a server system, such as a server system for use in the system shown in FIG. 2;

FIG. 5 is a schematic diagram showing operation of the shared access payment account system shown in FIG. 1; and

FIG. 6 is a flow chart of an example method for sharing a primary cardholder's primary account number with a secondary cardholder.

The figures are not intended to limit the present disclosure to the specific embodiments they depict. The drawings are not necessarily to scale. Like numbers in the Figures indicate the same or functionally similar components.

### DETAILED DESCRIPTION OF THE DISCLOSURE

The following detailed description of embodiments of the disclosure references the accompanying figures. The embodiments are intended to describe aspects of the disclosure in sufficient detail to enable those with ordinary skill in the art to practice the disclosure. The embodiments of the disclosure are illustrated by way of example and not by way of limitation. Other embodiments may be utilized, and changes may be made without departing from the scope of the claims. The following description is, therefore, not limiting. It is contemplated that the disclosure has general application to identifying and verifying entities requesting access to confidential information and/or financial services. The scope of the present disclosure is defined only by the appended claims, along with the full scope of equivalents to which such claims are entitled.

In this description, references to “one embodiment,” “an embodiment,” or “embodiments” mean that the feature or features referred to are included in at least one embodiment of the disclosure. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments but is not necessarily included. Thus, particular implementations of the present disclosure can include a variety of combinations and/or integrations of the embodiments described herein.

Broadly characterized, the present disclosure relates to systems and methods for sharing a primary cardholder's primary account number (PAN) with one or more secondary cardholders. More particularly, the disclosed embodiments provide a system and computer-implemented method for establishing a shared account number, transmitting the shared account number to one or more secondary cardholders, and placing limitations on the use of the shared account number by the secondary cardholders. In one example embodiment, a shared access payment account system is configured for use with a payment card processing network such as, for example, an interchange network. The shared access payment account system includes a memory device and a processor in communication with the memory device. The processor is programmed to create a shared account number. The shared access payment account system links a primary cardholder's PAN to the shared account number, adds one or more secondary cardholders to the shared account number, and receives limitations on the shared account number's use from the primary cardholder. When the secondary cardholders make transactions using the shared account number, the primary cardholder may receive notifications from the shared access payment account system including the details of the transactions.

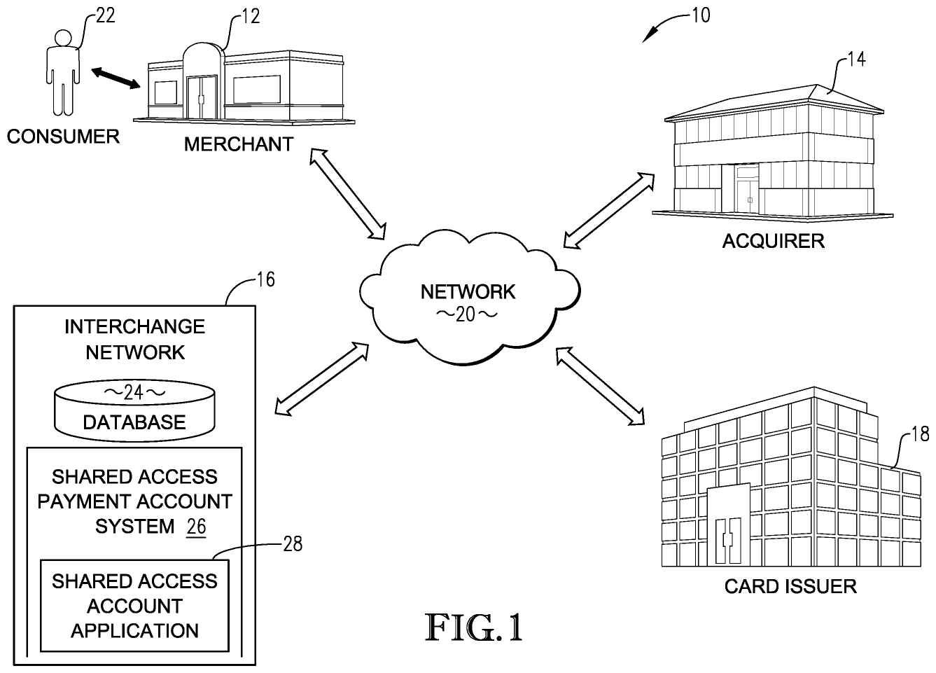

FIG. 1 is a block diagram of an example multi-party payment card network system 10 having a shared access payment account system 26. The payment card network system 10 facilitates providing interchange network services offered by an interchange network 16. In addition, the payment card network system 10 enables payment card transactions in which merchants 12, acquirers 14, and/or card issuers 18 do not need to have a one-to-one relationship. Although parts of the payment card network system 10 are presented in one arrangement, other embodiments may include the same or different parts arranged otherwise, depending, for example, on authorization processes for purchase transactions, communication between computing devices, etc.

In the example embodiment, the payment card network system 10 generally includes the merchants 12, the acquirers 14, the interchange network 16, and the issuers 18, coupled in communication via a network 20. The network 20 includes, for example and without limitation, one or more of a local area network (LAN), a wide area network (WAN) (e.g., the Internet, etc.), a mobile network, a virtual network, and/or any other suitable public and/or private network capable of facilitating communication among the merchants 12, the acquirers 14, the interchange network 16, and/or the issuers 18. In some embodiments, the network 20 may include more than one type of network, such as a private payment transaction network provided by the interchange network 16 to the acquirers 14 and the issuers 18 and, separately, the public Internet, which may facilitate communication between the merchants 12, the interchange network 16, the acquirers 14, and the consumers 22, etc.

Embodiments described herein may relate to a transaction card system, such as a credit card payment system using the Mastercard® interchange network. (Mastercard is a registered trademark of Mastercard International Incorporated.) The Mastercard interchange network is a set of proprietary communications standards promulgated by Mastercard International Incorporated for the exchange of financial transaction data and the settlement of funds between financial institutions that are members of Mastercard International Incorporated. As used herein, financial transaction data includes a unique account number associated with an account holder using a payment card issued by an issuer, purchase data representing a purchase made by the cardholder, including a type of merchant, amount of purchase, date of purchase, and other data, which may be transmitted between any parties of multi-party payment card network system 10.

In a typical transaction card system, a financial institution called the “issuer” issues a transaction card, such as a credit card, to a cardholder or consumer 22, who uses the transaction card to tender payment for a purchase from the merchant 12. In the example embodiment, the merchant 12 is typically associated with products, for example, and without limitation, goods and/or services, that are offered for sale and are sold to the consumers 22. The merchant 12 includes, for example, a physical location and/or a virtual location. A physical location includes, for example, a brick-and-mortar store, etc., and a virtual location includes, for example, an Internet-based store-front.

To accept payment with the transaction card, the merchant 12 must normally establish an account with a financial institution that is part of the payment card network system 10. This financial institution is usually called the “merchant bank,” the “acquiring bank,” or the acquirer 14. When the cardholder 22 presents payment for a purchase with, for example, a transaction card, a digital wallet, and the like, the merchant 12 requests authorization from the acquirer 14 for the amount of the purchase. The request may be performed over the telephone but is usually performed through the use of a point-of-sale terminal that reads the cardholder's account information from a magnetic stripe, a chip, or embossed characters on the transaction card and/or wirelessly via the digital wallet and communicates electronically with the transaction processing computers of the acquirer 14. Alternatively, the acquirer 14 may authorize a third party to perform transaction processing on its behalf. In this case, the point-of-sale terminal will be configured to communicate with the third party. Such a third party is usually called a “merchant processor,” an “acquiring processor,” or a “third party processor.”

Using the interchange network 16, computers of the acquirer 14 or merchant processor will communicate with computers of the issuer 18 to determine whether the cardholder's account is in good standing and whether the purchase is covered by the cardholder's available credit line. Based on these determinations, the request for authorization will be declined or accepted. If the request is accepted, an authorization code is issued to the merchant 12.

When a request for authorization is accepted, the available credit line of the cardholder's account is decreased. Normally, a charge for a payment card transaction is not posted immediately to the cardholder's account because bankcard associations, such as Mastercard International Incorporated, have promulgated rules that do not allow the merchant 12 to charge, or “capture,” a transaction until the purchased goods are shipped or the purchased services are delivered. However, with respect to at least some debit card transactions, a charge may be posted at the time of the transaction. When the merchant 12 ships or delivers the goods or services, the merchant 12 captures the transaction by, for example, appropriate data entry procedures on the point-of-sale terminal. This may include bundling of approved transactions daily for standard retail purchases. If the cardholder 22 cancels a transaction before it is captured, a “void” is generated. If the cardholder 22 returns goods after the transaction has been captured, a “credit” is generated. The interchange network 16 and/or the issuer 18 stores the transaction card information, such as, and without limitation, a type of merchant, a merchant identifier, a location where the transaction was completed, an amount of purchase, and a date and time of the transaction, in a database 24.

After a purchase has been made, a clearing process occurs to transfer additional transaction data related to the purchase among the parties to the transaction, such as the acquirer 14, the interchange network 16, and the issuer 18. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction.

After a transaction is authorized and cleared, the transaction is settled among the merchant 12, the acquirer 14, and the issuer 18. Settlement refers to the transfer of financial data or funds among the merchant 12, the acquirer 14, and the issuer 18 related to the transaction. Usually, transactions are captured and accumulated into a “batch,” which is settled as a group. More specifically, a transaction is typically settled between the issuer 18 and the interchange network 16, and then between the interchange network 16 and the acquirer 14, and then between the acquirer 14 and the merchant 12.

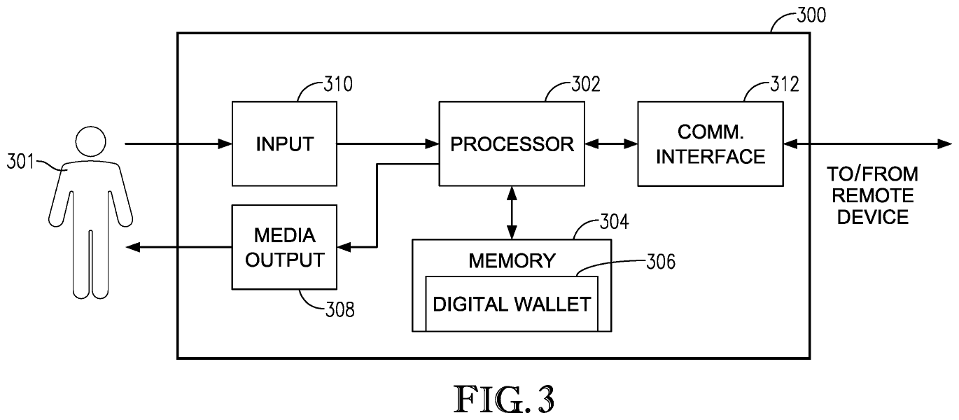

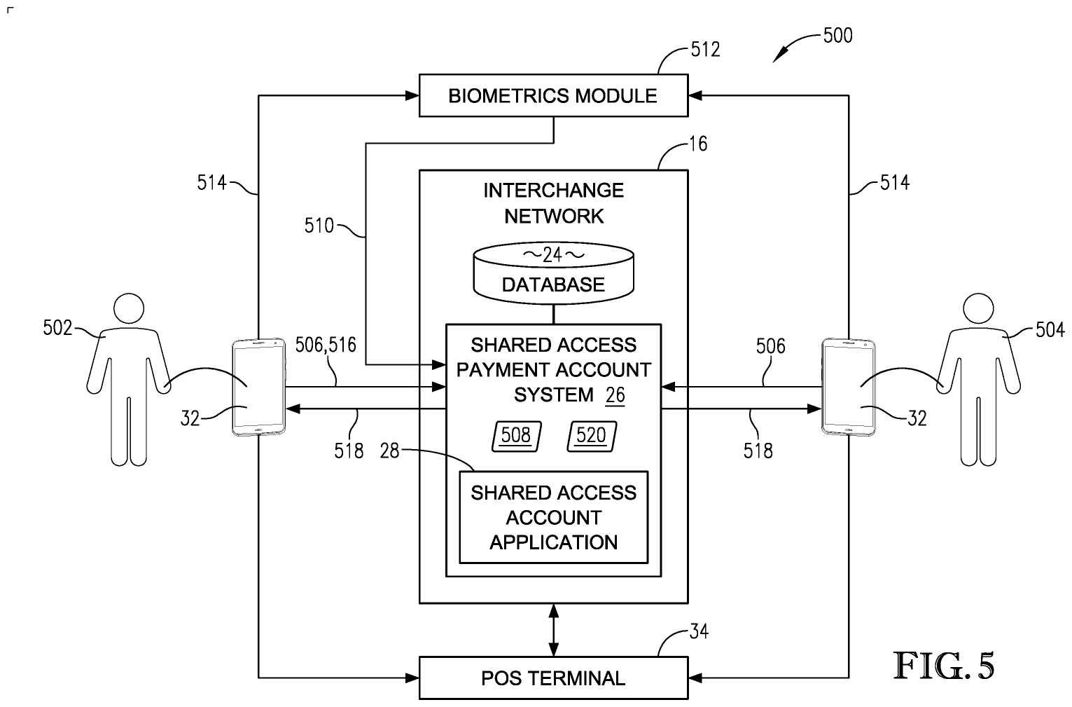

In some embodiments, the payment card transaction is a card-not-present transaction conducted, for example, with a payment card and/or virtual payment account number (virtual PAN) stored as digital wallet data in an electronic wallet or digital wallet 306 (shown in FIG. 3). The interchange network 16 includes the shared access payment account system 26 that is configured to analyze various data associated with the payment card transaction and provide various information to one or more parties involved in the payment card transaction, such as the merchant 12 and the acquirer 14. The shared access payment account system 26 is a specially programmed computer system that enables the interchange network 16 to receive, store, and/or transmit the following: (a) data related to a shared primary account number (PAN) or shared virtual PAN (shown in FIG. 5 as item 520); (b) notifications associated with the shared account number 520; and/or (c) user selected limitations associated with the shared account number 520. The shared access payment account system 26 includes a shared access account application 28 that facilitates communication between the shared access payment account system 26 and one or more authorized users or consumers 22 (shown in FIG. 1) of the shared account number 520, preferably via the user's digital wallet 306.

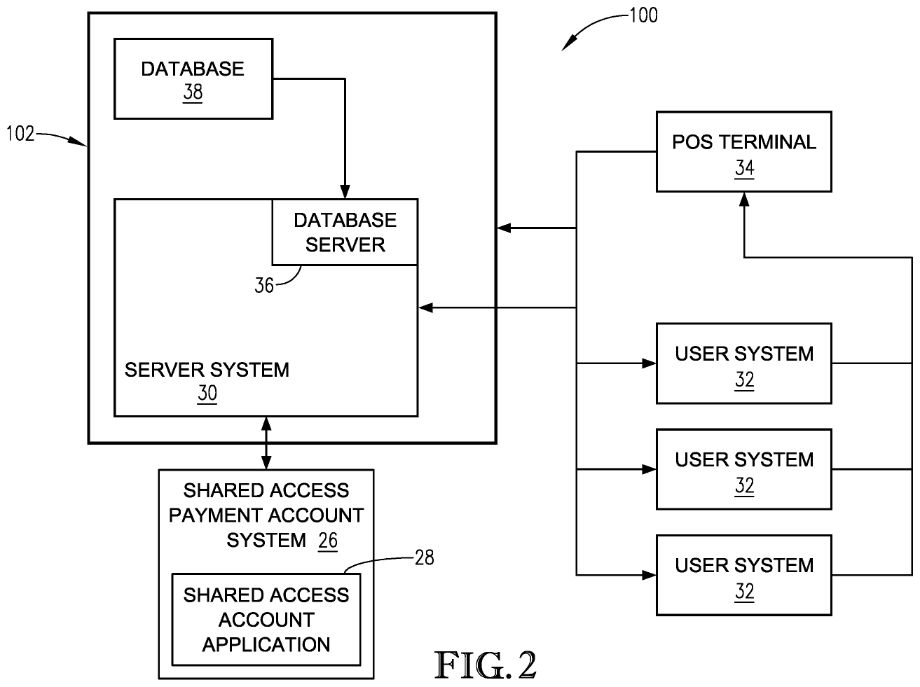

FIG. 2 is a simplified block diagram of an example transaction processing system (TPS) 102 for providing access to users 301 (shown in FIG. 3) to a shared PAN and/or virtual PAN using the shared access payment account system 26. In some embodiments, the payment network 100 is similar to the payment card network system 10 (shown in FIG. 1). In the example embodiment, the payment network 100 includes a plurality of computing devices connected in accordance with the present disclosure. The payment network 100 includes a server system 30 of the TPS 102 in communication with a point-of-sale (POS) terminal 34 at a merchant location 12 (shown in FIG. 1), and a plurality of user systems 32 associated with cardholders 22 (i.e., consumers).

More specifically, in the example embodiment, the TPS 102 includes the server system 30 of, for example, the interchange network 16 (shown in FIG. 1), in communication with the POS terminal 34 and the user systems 32 associated with the consumers 22. In one embodiment, the user systems 32 are mobile computing devices including a digital wallet, such as mobile phones, Smartphones, personal digital assistants (PDAs), key fobs, and/or computers, such that server system 30 is accessible to the user systems 32 using the Internet. The user systems 32 are interconnected to the Internet through one or more of many interface types including, for example, a network, such as a wireless network adapter or a wireless data transceiver for use with Bluetooth communication, radio frequency communication, near field communication (NFC), and/or with a mobile phone network, Global System for Mobile communications (GSM), 3G, or other mobile data network, and/or Worldwide Interoperability for Microwave Access (WiMax) and the like. The user systems 32 could be any device capable of interconnecting to the Internet including an Internet connected phone, a PDA, or any other suitable web-based connectable equipment.

In the example embodiment, the TPS 102 also includes one or more POS terminals 34, which may be connected to the user systems 32 and may be connected to the server system 30. The POS terminals 34 may be interconnected to the Internet (or any other network that allows the POS terminals 34 to communicate as described herein) through many interfaces including a network, such as a local area network (LAN) or a wide area network (WAN), dial-in-connections, cable modems, wireless modems, and special high-speed ISDN lines. The POS terminals 34 are any device capable of interconnecting to the Internet and including an input device capable of reading information from a cardholder's financial transaction card. In some embodiments, the POS terminal 34 may be a cardholder's personal computer, such as when conducting an online purchase through the Internet. As used herein, the terms POS device, POS terminal, and point of interaction device are used broadly, generally, and interchangeably to refer to any device in which a cardholder interacts with a merchant to complete a payment card transaction.

A database server 36 is connected to a database 38, which is configured to store information on a variety of matters, including the shared access account data as described below in greater detail. In one embodiment, the database 38 is a centralized database stored on the server system 30 and can be accessed by potential users at one of the user systems 32 by logging onto the server system 30 through one of the user systems 32. In an alternative embodiment, the database 38 is stored remotely from the server system 30 and may be a distributed or non-centralized database.

In one example embodiment, the database 38 may include a single database having separated sections or partitions or may include multiple databases, each being separate from each other. The database 38 may store transaction data generated as part of sales activities and savings activities conducted over the processing network including data relating to merchants, account holders or customers, issuers, acquirers, savings amounts, savings account information, and/or purchases made. The database 38 may also store account user identification data including, for example, at least one of a cardholder name, a cardholder address, an account number, and other account identifier. The database 38 may also store merchant data including a merchant identifier that identifies each merchant registered to use the network, and instructions for settling transactions including merchant bank account information. The database 38 may also store purchase data associated with items being purchased by a cardholder from a merchant, and authorization request data. The database 38 may also store digital wallet data 306, device information, a PAN and/or virtual PAN, shared account data, limitations associated with the shared account, and/or other data involved with providing access to an account number to one or more parties to the transaction.

In the example embodiment, one of the user systems 32 may be associated with the cardholder 22 (shown in FIG. 1) while the POS terminal 34 may be associated with the merchant 12 (shown in FIG. 1) or may be a computer system and/or mobile system used by the cardholder 22 while making an on-line purchase or payment. The server system 30 may be associated with the interchange network 16 or a payment processor. In the example embodiment, the server system 30 is associated with a financial transaction processing network, such as the interchange network 16, and may be referred to as an interchange computer system. The server system 30 may be used for processing transaction data. In addition, the user systems 32 and the POS terminal 34 may include a computer system associated with at least one of a merchant, an online bank, a bill payment outsourcer, an acquirer bank, an acquirer processor, an issuer bank associated with a transaction card, an issuer processor, a remote payment processing system, and/or a biller.

In the example embodiment, the TPS 102 is in communication with the shared access payment account system 26 and the shared access account application 28, which may be associated with the interchange network 16 or with an outside third party in a contractual relationship with the interchange network 16. In the example embodiment, the shared access payment account system 26 receives requests from a primary cardholder 502 (shown in FIG. 5), such as a cardholder 22, to link the primary cardholder's PAN and/or virtual PAN with a shared account number 520 (shown in FIG. 5) for sharing with one or more secondary cardholders 504 (shown in FIG. 5). In addition, the shared access payment account system 26 receives requests from the primary cardholder 502 to add one or more secondary cardholders 504 to the shared account 520 and also receives limitations 516 (shown in FIG. 5) to be placed on the shared account number 520 (shown in FIG. 5). The primary cardholders are generally cardholders 22 that hold the shared account number 520, set the limits on the shared account number 520, and are ultimately responsible for the debt accrued using the shared account number 520. In contrast, the secondary cardholders 504 are generally users 22 that the primary cardholder 502 wants to have control over regarding the secondary cardholder's use of the shared account number 520.

In some embodiments, the shared access payment account system 26 and/or the shared access account application 28 are also in communication with a merchant system and/or an issuer system (not shown) and/or the POS terminal 34 of the merchant 12. It is noted that the payment network 100 may include more, fewer, or alternative components and/or perform more, fewer, or alternative actions, including those discussed elsewhere herein.

FIG. 3 is an example configuration of a user computing device 300 operated by a user 301, such as the cardholder 22 (shown in FIG. 1). In some embodiments, the user computing device 300 is a user system 32 and/or a merchant POS terminal 34. In the example embodiment, the user computing device 300 includes a processor 302 for executing instructions. In some embodiments, executable instructions are stored in a memory device 304. The processor 302 includes one or more processing units, for example, in a multi-core configuration. The memory device 304 is any device allowing information, such as the digital wallet data 306, executable instructions, and/or written works, to be stored and retrieved. The memory device 304 includes one or more computer readable media.

The user computing device 300 also includes at least one media output component 308 for presenting information to the user 301. The media output component 308 is any component capable of conveying information to the user 301. In some embodiments, the media output component 308 includes an output adapter such as a video adapter and/or an audio adapter. An output adapter is operatively coupled to the processor 302 and operatively connectable to an output device such as a display device, such as a liquid crystal display (LCD), organic light emitting diode (OLED) display, or “electronic ink” display, or an audio output device, such as a speaker or headphones.

In some embodiments, the user computing device 300 includes an input device 310 for receiving input from the user 301. The input device 310 may include, for example, a touch sensitive panel, a touch pad, a touch screen, a stylus, a gyroscope, an accelerometer, a position detector, a keyboard, a pointing device, a mouse, or an audio input device. A single component such as a touch screen may function as both an output device of the media output component 308 and the input device 310. The user computing device 300 may also include a communication interface 312, which is communicatively connectable to a remote device such as the server system 30 and/or the POS terminal 34 (shown in FIG. 2). The communication interface 312 may include, for example, a wired or wireless network adapter or a wireless data transceiver for use with Bluetooth communication, radio frequency communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 304 are, for example, computer readable instructions for providing a user interface to the user 301 via the media output component 308 and, optionally, receiving and processing input from the input device 310. A user interface may include, among other possibilities, a web browser and a client application, such as a digital wallet application. Web browsers enable users, such as the user 301, to display and interact with media and other information typically embedded on a web page or a website from the server system 30. A client application allows the user 301 to interact with a server application, such as the shared access account application 28, from the server system 30.

In the exemplary embodiment, the computing device 300 is a user computing device from which the user 301 engages with a digital wallet 306, an online merchant (e.g., the merchant 12 shown in FIG. 1), an interchange network (e.g., the interchange network 16 shown in FIG. 1), and an issuer of a payment card (e.g., the issuer 18 shown in FIG. 1) to perform a payment transaction using, for example, a shared access account (e.g., a PAN and/or virtual PAN). Alternatively, rather than using a digital wallet 306, the user 301 may engage with a physical payment card associated with the shared account number 520.

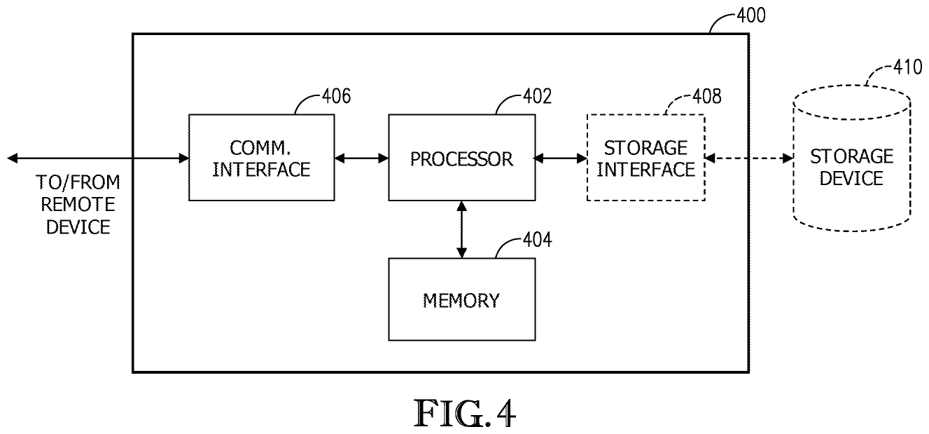

FIG. 4 is an example configuration of a server system 400, such as the server system 30 (shown in FIG. 2). The server system 400 includes, but is not limited to, the database 24 (shown in FIG. 1), the shared access payment account system 26, and/or the shared access account application 28. In the example embodiment, the server system 400 includes a processor 402 for executing instructions. The instructions may be stored in a memory area 404, for example. The processor 402 includes one or more processing units (e.g., in a multi-core configuration) for executing the instructions. The instructions may be executed within a variety of different operating systems on the server system 400, such as UNIX, LINUX, Microsoft Windows®, etc. More specifically, the instructions may cause various data manipulations on data stored in a storage device 410 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.).

The processor 402 is operatively coupled to a communication interface 406 such that the server system 400 can communicate with a remote device such as a user computing device 300 (shown in FIG. 3) or another server system 400. For example, the communication interface 406 may receive communications from a user system 32 via the Internet, as illustrated in FIG. 2.

The processor 402 is operatively coupled to the storage device 410. The storage device 410 is any computer-operated hardware suitable for storing and/or retrieving data. In some embodiments, the storage device 410 is integrated in the server system 400. In other embodiments, the storage device 410 is external to the server system 400 and is similar to the database 24. For example, the server system 400 may include one or more hard disk drives as the storage device 410. In other embodiments, the storage device 410 is external to the server system 400 and may be accessed by a plurality of server systems 400. For example, the storage device 410 may include multiple storage units such as hard disks or solid-state disks in a redundant array of inexpensive disks (RAID) configuration. The storage device 410 may include a storage area network (SAN) and/or a network attached storage (NAS) system.

In some embodiments, the processor 402 is operatively coupled to the storage device 410 via a storage interface 408. The storage interface 408 is any component capable of providing the processor 402 with access to the storage device 410. The storage interface 408 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 402 with operable access to the storage device 410.

The memory area 404 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

In the example embodiment, the server system 400 is a shared access payment account system in communication with one or more of the user system 32 (shown in FIG. 2), the interchange network 16, and/or the merchant 12 during a payment card transaction involving the digital wallet 306 (shown in FIG. 3) of a user, such as the cardholder 22 (shown in FIG. 1). The server system 400 performs checking for shared access account numbers and account information updates and/or limitations for accounts initiating a payment transaction. In alternative embodiments, the payment card transaction may include a physical payment card that is read by the POS device 34 (shown in FIG. 2) rather than the digital wallet 306.

FIG. 5 is a schematic diagram showing operation of the shared access payment account system 26. As described herein, the shared access payment account system 26 is configured to receive requests from a primary cardholder 502 to link the primary cardholder's PAN and/or virtual PAN with the shared account number 520 for sharing with one of more secondary cardholders 504. In addition, the shared access payment account system 26 receives requests from the primary cardholder 502 to add one or more secondary cardholders, such as secondary cardholders 504, and receives limitations to be placed on the shared account number 520, i.e., the primary cardholder's PAN and/or virtual PAN. In some embodiments, the shared access payment account system 26 and/or the shared access account application 28 are also in communication with a merchant system and/or an issuer system (not shown) and/or the POS terminal 34 of the merchant 12. In the example embodiment, the shared access payment account system 26 is a component of a payment network, such as payment card interchange network 16.

In the example embodiment, the shared access payment account system 26 is programmed to communicate with one or more client systems 32 to receive user identification data 506 to facilitate activating a user, such as the primary cardholder 502 and the secondary cardholders 504, that is not registered with the shared access payment account system 26. In particular, the user activation process creates a user account and associated credentials for use with the shared access payment account system 26 and/or the shared access account application 28. The user, such as the primary cardholder 502 and the secondary cardholders 504, enters the user identification data 506 for transmission to the shared access payment account system 26. The user identification data 506 may include, for example, and without limitation, personal data relating to the identity of the user, such as the primary cardholder 502 and the secondary cardholders 504. Specifically, the identification data 506 may include personal identifying information of the user, such as the user's name, email address, password, cellular phone number, etc. The user identification data 506 is stored in the database 24. The shared access payment account system 26 generates a user account 508 from the user identification data 506 for the user.

Furthermore, in the example embodiment, the shared access payment account system 26 is programmed to receive a biometric profile 510 from a biometrics module 512. The biometric profile 510 may include, for example, biometrics of the user, such as the primary cardholder 502 and the secondary cardholders 504. As is customary, the biometrics of the user includes one or more scans or digital representations 514 of physical features of the user that are to be validated during account setup and/or sharing of the primary cardholder's PAN and/or virtual PAN. The biometrics or physical features can include, for example, and without limitation, voice, fingerprint, iris, vein pattern, face, or the like. Feature data from a biometric scan or digital representation may be extracted to select features of interest. The biometric profile 510 may be stored, for example, in the database 24. The shared access payment account system 26 supplements the user profile 508 with the biometric profile 510. The biometrics module 512 is programmed to receive the one or more scans or digital representations 514 of physical features from the client systems 32 and use them to generate the biometric profile 510 and/or validate the one or more scans or digital representations 514 against the biometric profile 510.

Additionally, in the exemplary embodiment, the shared access payment account system 26 allows for communication between the shared access account application 28 and the digital wallet 306 (shown in FIG. 3) to send, receive, and store information related to, for example, and without limitation, the shared account number 520, limitations 516 set for the secondary cardholders 504 associated with the shared account number 520, notifications 518 of transactions made though the shared account number 520, etc.

In the exemplary embodiment, the primary cardholder 502 may establish the shared account number 520 and may link one or more PANs and/or virtual PANs to the shared account number 520. The primary cardholder 502 may also establish one or more limitations 516 for the shared account number 520, as described herein, and store those limitations in the shared access payment account system 26. After establishing the shared account number 520, the primary cardholder 502 may invite one or more secondary cardholders 504 to link to the shared account number 520. For example, and without limitation, the primary cardholder 502 may choose one or more secondary cardholders 504 having a user account 508 with the shared access payment account system 26, using for example, the shared access account application 28. The secondary cardholders 504 may receive a notification 518 that a shared account number 520 is available for use. Alternatively, in some embodiments, the primary cardholder 502 may send a message, such as an SMS message, to one or more of the secondary cardholders 504 notifying them that a shared account number 520 is available for use. If the secondary cardholders 504 do not have a user account 508 with the shared access payment account system 26, the secondary cardholders may establish a user account and access the shared account number 520. In such an example, the SMS message may include a link or other identifier, identifying the shared account number 520 established by the primary cardholder 520.

As discussed above, the shared access payment account system 26 stores limitations 516 that are established by the primary cardholder 502. The limitation 516 may be established, for example, by specifying restrictions or approvals of the use of the shared account number 520 by one or more of the secondary cardholders 504. In the exemplary embodiment, the limitations can be based on, for example, and without limitation, transaction number limit (e.g., a one-time transaction, multiple transactions, etc.), time limit, spending amount, geolocation of the user system 32, merchant category codes (MCCs), merchant names, and/or other merchant identifiers. Furthermore, when the secondary cardholders 504 make a transaction at a POS terminal 34, for example, the transaction data is checked against the shared access payment system 26 by the interchange network 16, and the shared access payment account system 26 accepts or denies the transaction depending on the limitations that the primary cardholder 502 has put on the secondary cardholder's use of the shared account number 520. It is noted that the primary cardholder 502 may establish different limitations for different secondary cardholders 504. For example, and without limitation, a spending limit limitation may be placed on the shared account number 520 for a first secondary cardholder, and a geolocation limit may be placed on the shared account number 520 for a second secondary cardholder 504.

In one embodiment, the MCCs, merchant names, and/or other merchant identifiers used to limit transactions may be assigned to selected types of merchants, such as grocery store, liquor stores, clothing stores, restaurants, and the like, or they may be assigned to specific stores within the selected types of stores. Therefore, when the secondary cardholders 504 use the digital wallet 306 as a payment device at a merchant 12 to make a transaction, the POS device 34 of the merchant 12 sends an MCC identifier and/or another merchant identifier (e.g., a merchant ID) to the interchange network 16 and the shared access payment account system 26 in an authorization message. The shared access payment account system 26 checks the MCC against a list of approved and/or disapproved MCC based on the limitations set by the primary cardholder 502. The shared access payment account system 26 declines the transaction if it violates a limitation 516 imposed on the shared account number 520 and allows the transaction if it does not. Furthermore, in some suitable embodiments, the limitations 516 may include a spending limit, a time limit, and/or a geolocation limit. If any of the limitations 516 are violated, the transaction is declined by the shared access payment account system 26. As such, the shared access payment account system 26 facilitates the primary cardholder 502 to control the types and amounts of transactions that the secondary cardholders 504 can make with the shared account number 520.

In some embodiments, the shared access account application 28 may send notifications 518 to the primary cardholder 502 regarding transactions made by the secondary cardholders 504, including for example, whether the transaction violated one or more limitations 516. The shared access payment account system 26 allows the primary cardholder 502 and secondary cardholders 504 to access the shared account number 520 through the shared access account application 28 on the shared access payment account system 26 or through the cardholder's digital wallet 306 on the client system 32, to view any limitations 516 associated with the shared account number 520.

In the exemplary embodiment, the shared access account application 28 allows the primary cardholder 502 to create, edit, and view the limitations 516 by accessing the shared access payment account system 26, for example, and without limitation, via a user computing device 300 (shown in FIG. 3) or the user system 32 (shown in FIG. 2) via the digital wallet 306, a mobile application, and/or via a web browser (not shown). In the exemplary embodiment, the shared account number 520 and the limitations 516 are transferred to the secondary cardholder's digital wallet 306 after user authentication described above. The secondary cardholder 504 may view the limitations 516 in the digital wallet 306 and may use the digital wallet 306 to transmit the shared account number 520 information to a merchant 12, for example, via the POS device 34. For example, the secondary cardholder 504 may enter into a transaction by placing the user system 32 (i.e., a smartphone, PDA, or the like) near the POS device 34 to facilitate transmission of the shared account number 520 data to the POS device 34. Alternatively, the shared account number 520 and the limitations 516 are accessible to a physical payment card associated with the shared account.

In the exemplary embodiment, the shared access account application 28 allows the primary cardholder 502 to access the shared account number 520 to edit the limitations 516 (e.g., change spending limits, time limits, add or remove secondary cardholders 504, etc.) at any time after the shared account number 520 is established. Any changes made to the limitations 516 of the shared account number 520 may be transmitted automatically to the secondary cardholder's digital wallet 306 and/or are automatically applied to the physical payment card associated with the shared account. Furthermore, the primary cardholder 502 may cancel the shared account number 520 at any time. As such, the shared account number 520 will automatically be removed from the secondary cardholder's digital wallet 306 and/or the physical payment card will no longer have access to the shared account number 520, thus becoming invalid.

Furthermore, in other embodiments, the primary cardholder 502 may choose to manually allow a transaction being made by the secondary cardholder 504. For example, if a large purchase is anticipated, the primary cardholder 502 may choose to be notified via a notification 518 when the transaction is being attempted. The primary account holder may then be given the option to deny or allow the transaction to continue, for example, via the shared access account application 28 and or the primary cardholder's digital wallet 306.

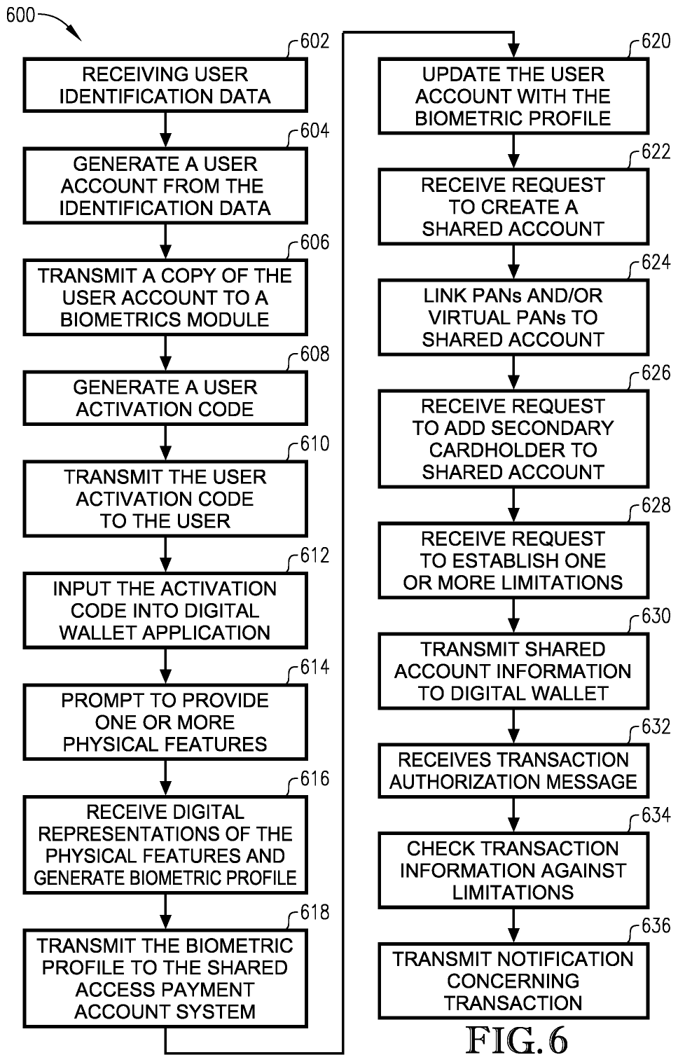

FIG. 6 shows a flow chart of an example method 600 for sharing a primary cardholder's primary account number (PAN) with one or more secondary cardholders. In the example embodiment, the method 600 is implemented by the shared access payment account system 26 (shown in FIG. 1). The method 600 is a computer-implemented method for receiving requests from the primary cardholder 502 (shown in FIG. 5) to link the primary cardholder's PAN and/or virtual PAN with the shared account number 520 (shown in FIG. 5) for sharing with one or more secondary cardholders 504 (shown in FIG. 5) and receiving limitations 516 (shown in FIG. 5) to be placed on the shared account number 520 from the primary cardholder 502.

In the example method 600, an operation 602 includes receiving user identification data, such as user identification data 506 (shown in FIG. 5) to facilitate activating a user, such as the primary cardholder 502 and the secondary cardholders 504, that is not registered with the shared access payment account system 26 (shown in FIG. 1). For example, when a user, such as the primary cardholder 502 or the secondary cardholders 504, signs up for a user account on the shared access payment account system 26, the shared access payment account system 26 requests certain identification data from the user in order to generate the user account 508 (shown in FIG. 5). The user identification data 506 may be stored in the database 24 (shown in FIG. 1). The method 600 includes an operation 604 that includes generating the user account 508 from the user identification data 508 for each respective user.

After the user account 508 is complete and the user (e.g., the primary or secondary cardholders 502 and 504, respectively) has been setup or onboarded with the shared access payment account system 26, the method 600 proceeds with authenticating the user, as shown in FIG. 6. In the example embodiment, an operation 606 includes transmitting a copy of the user account 508 to the biometrics module 512 (shown in FIG. 5). At operation 608, upon receipt of the user account 508, the biometrics module 512 generates a user activation code. The biometrics module 512 then transmits the user activation code to the user via the user's email address at operation 610.

In the example method 600, at operation 612, the user inputs the activation code into the user's digital wallet application 306 (shown in FIG. 3) installed, for example, on the client system 32, such as the user's cellular phone or a computer including one or more biometric sensors. Alternatively, a physical payment card may be issued to the user. In the exemplary embodiment, the user receives the email containing the activation code from the biometrics module 512. In one example, at operation 614, the user may then be prompted to provide one or more physical features to the shared access payment account system 26 via a biometric sensor coupled to the client system 32. The method 600 further includes an operation 616 for receiving one or more scans or digital representations 514 (shown in FIG. 5) of the physical features of the user and generates the biometric profile 510 (shown in FIG. 5) for the user. At operation 618, the biometric module 512 transmits the biometric profile 510 to the shared access payment account system 26, which updates 620 the user account 508 with the biometric profile 510. After the user account 508 is updated with the biometric profile 510, the user may access the user account 508 by logging in and providing a biometric sample to the shared access payment account system 26.

At operation 622, the shared access payment account system 26 receives a request from the user, such as the primary cardholder 502, to create a shared account number 520 (shown in FIG. 5). The primary cardholder 502 may link one or more PANs and/or virtual PANs to the shared account number 520 at operation 624.

At operation 626, the shared access payment account system 26 receives a request to add one or more secondary cardholders 504 to the shared account number 520. As described herein, the secondary cardholders 504 may receive a notification 518 (shown in FIG. 5) that the shared account number 520 is available for use.

At operation 628, the shared access payment account system 26 receives a request from the primary cardholder 502 to establish one or more limitations 516 (shown in FIG. 5) for the shared account. The limitations 516 may be established, for example, by specifying restrictions or approvals of the use of the shared account number 520 by the secondary cardholders 504. As described above, the limitations 516 can be based on, for example, and without limitation, transaction number limit (e.g., a one-time transaction, multiple transactions, etc.), time limit, spending amount, geolocation of the user system 32, MCCs, merchant names, and/or other merchant identifiers. The shared access payment account system 26 stores the limitations 516 that are established by the primary cardholder 502, for example, in database 24.

At operation 630, the shared access payment account system 26 transmits the shared account information, e.g., the linked PANs and/or virtual PANs, to the secondary cardholder's digital wallet 306. Alternatively, the shared access payment account system 26 associates a physical payment card with the shared account. At an operation 632, the shared access payment account system 26 receives a transaction authorization message. The shared access payment account system 26 checks transaction information contained in the authorization message against the limitations 516 established for the shared account number 520 at operation 634. The shared access payment account system 26 declines the transaction if it is determined that the transaction violates a limitation 516 imposed on the shared account number 520 and allows the transaction if it is determined that it does not. At operation 636, the shared access account application 28 transmits notifications 518 to the primary cardholder 502 including details of transactions made by the secondary cardholder 504, including for example, whether the transaction violated one or more limitations 516. In one embodiment, the notifications may include an authorization request. In such an embodiment, the primary cardholder 502 may choose to manually allow a transaction being made by the secondary cardholder 504. As such, the shared access payment account system 26 receives authorization for the transaction from the primary cardholder 502 and allows the transaction to continue.

Any actions, functions, operations, and the like recited herein may be performed in the order shown in the figures and/or described above or may be performed in a different order. Furthermore, some operations may be performed concurrently as opposed to sequentially. Although the computer-implemented method is described above, for the purpose of illustration, as being executed by an example system and/or example physical elements, it will be understood that the performance of any one or more of such actions may be differently distributed without departing from the spirit of the present disclosure.

A computer-readable storage media or medium comprising a non-transitory medium may include an executable computer program stored thereon and for instructing one or more processing elements to perform some or all of the operations described herein, including some or all of the operations of the computer-implemented method. The computer program stored on the computer-readable medium may instruct the processor and/or other components of the system to perform additional, fewer, or alternative operations, including those discussed elsewhere herein.

All terms used herein are to be broadly interpreted unless otherwise stated. For example, the term “payment card” and the like may, unless otherwise stated, broadly refer to substantially any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transaction card can be used as a method of payment for performing a transaction.

The terms “processor,” “processing element,” and the like, as used herein, may, unless otherwise stated, broadly refer to any programmable system including systems using central processing units, microprocessors, microcontrollers, reduced instruction set circuits (RISC), application specific integrated circuits (ASIC), logic circuits, and any other circuit or processor capable of executing the functions described herein. The above examples are example only and are thus not intended to limit in any way the definition and/or meaning of the term “processor.” In particular, a “processor” may include one or more processors individually or collectively performing the described operations. In addition, the terms “software,” “computer program,” and the like, may, unless otherwise stated, broadly refer to any executable code stored in memory for execution on mobile devices, clusters, personal computers, workstations, clients, servers, and a processor or wherein the memory includes read-only memory (ROM), electronic programmable read-only memory (EPROM), random access memory (RAM), erasable electronic programmable read-only memory (EEPROM), and non-volatile RAM (NVRAM) memory. The above memory types are example only and are thus not limiting as to the types of memory usable for storage of a computer program.

The terms “computer,” “computing device,” “computer system,” and the like, as used herein, may, unless otherwise stated, broadly refer to substantially any suitable technology for processing information, including executing software, and may not be limited to integrated circuits referred to in the art as a computer, but may broadly refer to a microcontroller, a microcomputer, a programmable logic controller (PLC), an application specific integrated circuit, and other programmable circuits, and these terms are used interchangeably herein.

The term “network,” “communications network,” and the like, as used herein, may, unless otherwise stated, broadly refer to substantially any suitable technology for facilitating communications (e.g., GSM, CDMA, TDMA, WCDMA, LTE, EDGE, OFDM, GPRS, EV-DO, UWB, WiFi, IEEE 802 including Ethernet, WiMAX, and/or others), including supporting various local area networks (LANs), personal area networks (PAN), or short-range communications protocols.

The term “communication component,” “communication interface,” and the like, as used herein, may, unless otherwise stated, broadly refer to substantially any suitable technology for facilitating communications, and may include one or more transceivers (e.g., WWAN, WLAN, and/or WPAN transceivers) functioning in accordance with IEEE standards, 3GPP standards, or other standards, and configured to receive and transmit signals via a communications network.

The term “memory area,” “storage device,” and the like, as used herein, may, unless otherwise stated, broadly refer to substantially any suitable technology for storing information, and may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others.

Although the disclosure has been described with reference to the one or more embodiments illustrated in the figures, it is understood that equivalents may be employed, and substitutions made herein without departing from the scope of the disclosure as recited in the claims.

Having thus described one or more embodiments of the disclosure, what is claimed as new and desired to be protected by Letters Patent includes the following:

What is claimed is:

1. A shared access payment account system for sharing a primary account number among cardholders, said shared access payment account system comprising:
a memory device for storing data; and
a processor communicatively coupled to said memory device, said processor programmed to:
receive user identification data corresponding to a primary cardholder, the user identification data including personal data relating to the identity of the primary cardholder,
generate a user account from the user identification data for the primary cardholder,
receive a request from the primary cardholder to create a shared account number,
receive a request from the primary cardholder to link the primary account number to the shared account number,
receive a request from the primary cardholder to create one or more limitations on the use of the shared account number by a secondary cardholder,
store the shared account number and the one or more limitations in the memory device as shared account number data,
transmit the shared account number data to the secondary cardholder,
receive a transaction authorization message associated with a transaction by the shared account number,
determine whether the transaction violates at least one of the one or more limitations, and
decline the transaction if one or more of the limitations are violated.

2. The shared access payment account system in accordance with claim 1,
said processor programmed to receive a request from the primary cardholder to add the secondary cardholder to the shared account number.

3. The shared access payment account system in accordance with claim 2,
said processor programmed to transmit a notification to the secondary cardholder that the shared account number is ready for use.

4. The shared access payment account system in accordance with claim 1,
said processor programmed to transmit a notification to the primary cardholder including details of transactions made by the secondary cardholder.

5. The shared access payment account system in accordance with claim 4,
said notification including whether the transaction violated at least one of the one or more limitations.

6. The shared access payment account system in accordance with claim 1,
said processor programmed to:
generate an activation code for the primary cardholder;
transmit the activation code to the primary cardholder;
receive, from the primary cardholder, one or more biometrics of the primary cardholder; and
update the user account with the one more biometrics.

7. The shared access payment account system in accordance with claim 6,
further comprising a biometrics module programmed to generate a biometric profile of the primary cardholder based on the one or more biometrics of the primary cardholder.

8. The shared access payment account system in accordance with claim 1,
said processor being further programmed to, as part of receiving the request from the primary cardholder to create one or more limitations, specify restrictions or approvals of the use of the shared account number by the secondary cardholder.

9. The shared access payment account system in accordance with claim 8, wherein the one or more limitations includes one or more of the following: a transaction number limit, a time limit, a spending amount, a geolocation for use of the shared account number, a merchant category code, and a merchant name.

10. The shared access payment account system in accordance with claim 1,
said processor programmed to allow the transaction to be processed if none of the one or more limitations are violated.

11. The shared access payment account system in accordance with claim 1,
said processor programmed to transmit a notification to the primary cardholder requesting authorization of the transaction by the primary cardholder.

12. The shared access payment account system in accordance with claim 11,
said processor programmed to receive authorization of the transaction from the primary cardholder and allows the transaction to be processed.

13. The shared access payment account system in accordance with claim 1,
said processor programmed to receive a request to modify the one or more limitations.

14. The shared access payment account system in accordance with claim 1,
said processor programmed to receive a request to cancel the shared account number.

15. A computer-implemented method for sharing a primary account number among cardholders, said method comprising:
receiving user identification data corresponding to a primary cardholder, the user identification data including personal data relating to the identity of the primary cardholder;
generating a user account from the user identification data for the primary cardholder;
receiving a request from the primary cardholder to create a shared account number;
receiving a request from the primary cardholder to link the primary account number to the shared account number;
receiving a request from the primary cardholder to create one or more limitations on the use of the shared account number by a secondary cardholder;
storing the shared account number and the one or more limitations in the memory device as shared account number data;
transmitting the shared account number data to the secondary cardholder;
receiving a transaction authorization message associated with a transaction by the shared account number;
determining whether the transaction violates at least one of the one or more limitations; and
declining the transaction if one or more of the limitations are violated.

16. The method in accordance with claim 15, further comprising receiving a request from the primary cardholder to add the secondary cardholder to the shared account number.

17. The method in accordance with claim 16, further comprising transmitting a notification to the secondary cardholder that the shared account number is ready for use.

18. The method in accordance with claim 15, further comprising transmitting a notification to the primary cardholder including details of transactions made by the secondary cardholder.

19. The method in accordance with claim 15, further comprising allowing the transaction to be processed if none of the one or more limitations are violated.

20. The method in accordance with claim 15, further comprising transmitting a notification to the primary cardholder requesting authorization of the transaction by the primary cardholder.
